(19) United States
(12) Patent Application Publication
(10) Pub. No.: US 2019/0048493 A1
(43) Pub. Date: Feb. 14, 2019

(54) CARBON FIBER BUNDLE FORMING DEVICE AND METHOD

(71) Applicant: Ching-Long ONG, TAICHUNG CITY (TW)

(72) Inventor: Ching-Long ONG, TAICHUNG CITY (TW)

(21) Appl. No.: 15/676,919

(22) Filed: Aug. 14, 2017

(51) Int. Cl. D02G 3/40; B29B 15/12; B29C 47/00; B29C 70/50; C08J 5/24; D01F 9/12

(52) U.S. Cl. CPC D02G 3/40; B29B 15/12; B29C 47/0014; B65H 54/02; B29C 70/50; C08J 5/24; D01F 9/12; B29C 47/0004

(57) ABSTRACT

A carbon fiber bundle forming method, wherein the at least one carbon fiber bundle can be evenly heated since it is heated with microwave in the first and second microwave steps. Besides, the at least one carbon fiber bundle is treated in the laser step, laser can reach into the interior of the at least one carbon fiber bundle to enable the carbonization and graphitization to take place more evenly, then the carbon fiber bundle is treated in the subsequent roughening treatment step, the resin forming step and the semi-cure forming step, so that the interior of the at least one carbon fiber bundle can be heated evenly, which allows the at least one carbon fiber bundle to be carbonized evenly.

### BACKGROUND

### Field of the Invention

The present invention relates to a carbon fiber, and more particularly to a carbon fiber forming device and a carbon fiber forming method.

### Related Prior Art

A conventional carbon fiber bundle forming method is firstly to squeeze the raw material into filaments which are then carbonized, as shown in FIG. 1, and includes the following processes: the carbonized carbon fiber bundle should firstly go through a dehumidification stage 110 which includes: a first vacuum dehumidification step 111, a first dew point dehumidification step 112, a second vacuum dehumidification step 113 and a second dew point dehumidification step 114. With the dehumidification stage 110, moisture can be removed to dry the carbon fiber bundle.

Then, the dried carbon fiber bundle goes through a first heating stage 120 which can be electric resistance heating or gas heating and includes: a preheating step 121, a first heating step 122, and a second heating step 123. The preheating step 121 is to heat the carbon fiber bundle from room temperature to 100° C., the first heating step 122 is to heat the carbon fiber bundle from 100° C. to 260° C., and the second heating step 123 is to heat the carbon fiber bundle from 260° C. to 500° C. The first heating stage 120 can stabilize the carbon fiber bundle.

The heated carbon fiber bundle then goes through a sizing process, in which the carbon fiber bundle is immersed in resin and then dried, so that the filamentous raw material is covered with a layer of resin, and the total amount of the resin is 5%-6% of the filamentous raw material, so as to prevent the filamentous raw materials from sticking together, finally, the filamentous material coated with resin is rolled up and to be used for subsequent carbonization.

After that, the stabilized carbon fiber bundle goes through a second heating stage 130 which includes: a third heating step 131 and a fourth heating step 132, the third heating step 131 is to heat the carbon fiber bundle from 500° C. to 850° C., and the fourth heating step 132 is to heat the carbon fiber bundle from 1000° C. to 1500° C. The second heating stage 130 is used to carbonize the carbon fiber bundle.

Finally, the carbonized carbon fiber bundle goes through a third heating stage 140 which includes: a fifth heating step 141 used to graphitize the carbon fiber bundle by heating it 1500° C. to 3000° C.

The carbon fiber bundle then continues to go through a sizing process for later use, and can also be treated with a gluing process based to meet different requirements. For example, pressing a resin film on the carbon fiber bundle and then heating the carbon fiber bundle, thus the resin film is adhered to the carbon fiber bundle; or immersing the carbon fiber bundle into the resin, so that the carbon fiber bundle can be glued with different methods according to different uses.

However, the overall carbonization time of the carbon fiber bundle is too long, and in the first, second and third heating stages, the carbon fiber bundle is heated with electric resistance heat which heats the outer surface of the carbon fiber bundle, so that carbonization starts from exterior of the carbon fiber bundle and is fully completed via several heating steps. Since the carbonization starts from the exterior, and the interior carbonization speed is different from that of the exterior carbonization, which results in an uneven carbonization of the carbon fiber bundle. Besides, the carbon fiber bundle should be warmed slowly, and it takes 5-10 hours from the dehumidification stage 110 to the third heating stage to complete the graphitization, and as a result, the carbonization of the carbon fiber bundle is uneven and too long.

The present invention has arisen to mitigate and/or obviate the afore-described disadvantages.

### SUMMARY

One objective of the present invention is to provide a carbon fiber bundle forming device and method, wherein the carbon fiber bundle can be evenly carbonized and rolled up for later use.

Another objective of the present invention is to reduce the overall carbonization time of the carbon fiber bundle.

To achieve the above objectives, a carbon fiber bundle forming method in accordance with the present invention comprises:

a dehumidification step serving to dry at least one carbon fiber bundle;

an induction heating step serving to stabilize the at least one carbon fiber bundle by induction heating the at least one carbon fiber bundle from a room temperature to 500° C.;

a first microwave step serving to carbonize the at least one carbon fiber bundle by microwave heating the at least one carbon fiber bundle from 500° C. to 1000° C.;

a second microwave step serving to graphitize the at least one carbon fiber bundle by microwave heating the at least one carbon fiber bundle from 1000° C. to 1500° C.;

a laser step serving to heat the at least one carbon fiber bundle from 1500° C. to 3000° C. with laser illumination, so that graphitization takes place inside the at least one carbon fiber bundle;

a roughening treatment step serving to form a plurality of pits in an outer surface of the at least one carbon fiber bundle;

a resin forming step enabling a resin to be adhered to the outer surface of the at least one carbon fiber bundle in a high pressure manner, and allowing the resin to permeate into an interior of the at least one carbon fiber bundle via the pits, so that the outer surface and the interior of the at least one carbon fiber bundle is filled with the resin; and

a semi-cure forming step serving to bring the at least one carbon fiber bundle into a semi-cured state by controlling environmental temperature and pressure of the at least one carbon fiber bundle.

The at least one carbon fiber bundle can be evenly heated since it is heated with microwave in the first and second microwave steps. Besides, the at least one carbon fiber bundle is treated in the laser step, laser can reach into the interior of the at least one carbon fiber bundle, so that the interior of the at least one carbon fiber bundle can be heated evenly, which allows the at least one carbon fiber bundle to be carbonized evenly.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a flow chart of a conventional method of carbonization of carbon fiber bundle;

FIG. 2 is an illustrative view of a carbon fiber bundle forming device in accordance with a preferred embodiment of the present invention;

FIG. 3 is a flow chart showing the steps of a carbon fiber bundle forming method in accordance with a preferred embodiment of the present invention;

FIG. 4 is an illustrative view of the present invention showing the step of immersing the carbon fiber bundle;

FIG. 5 shows the carbon fiber bundle made by the carbon fiber bundle forming method in accordance with the preferred embodiment of the present invention;

FIG. 6 is an illustrative view of the present invention showing the step of roughening treatment of the carbon fiber bundle; and

FIG. 7 is an illustrative view showing shows the carbon fiber bundle made by the carbon fiber bundle forming method in accordance with the preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

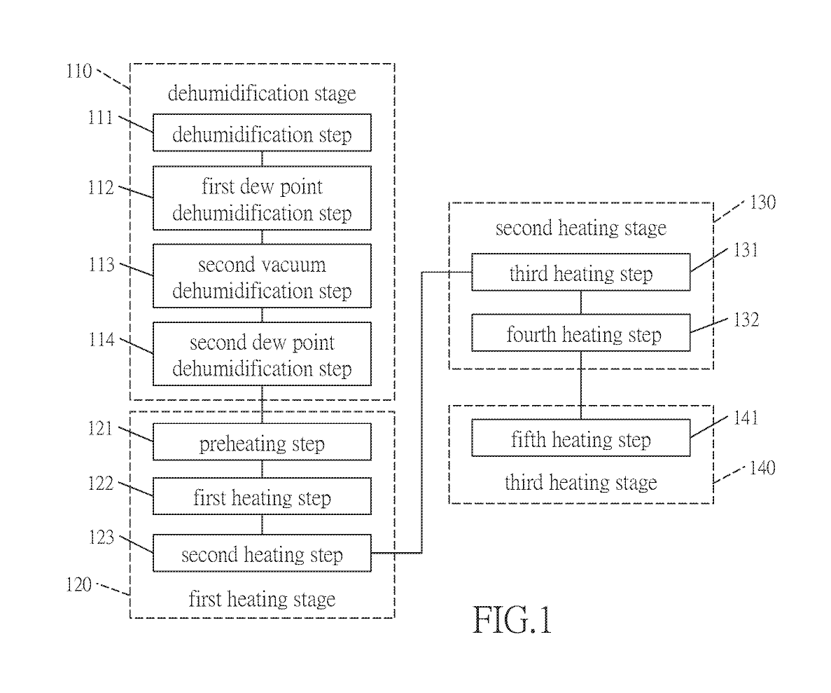

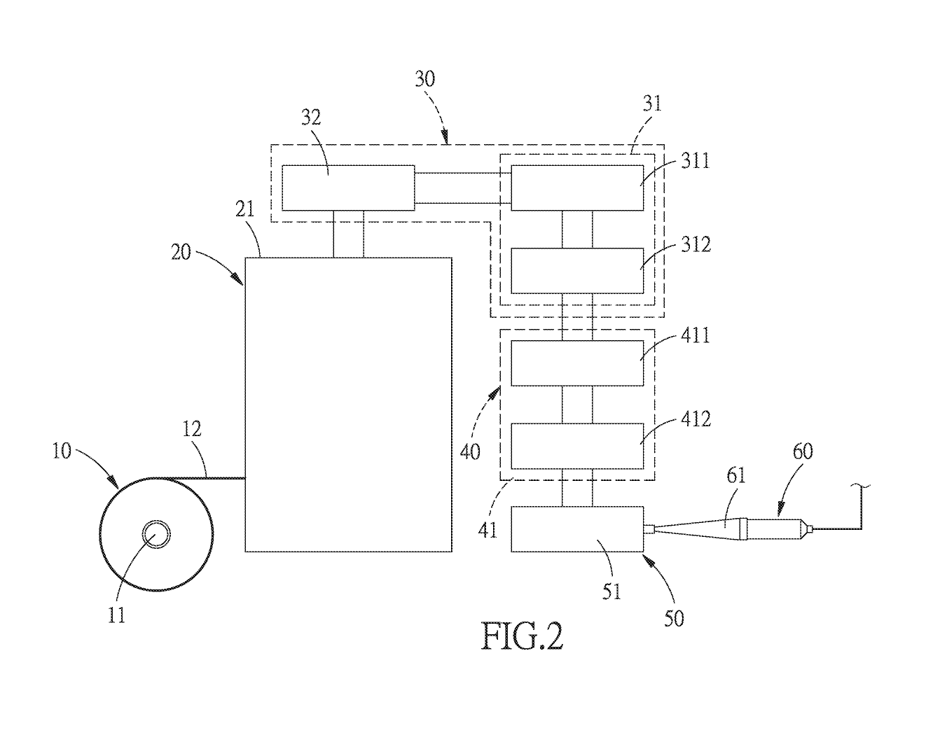

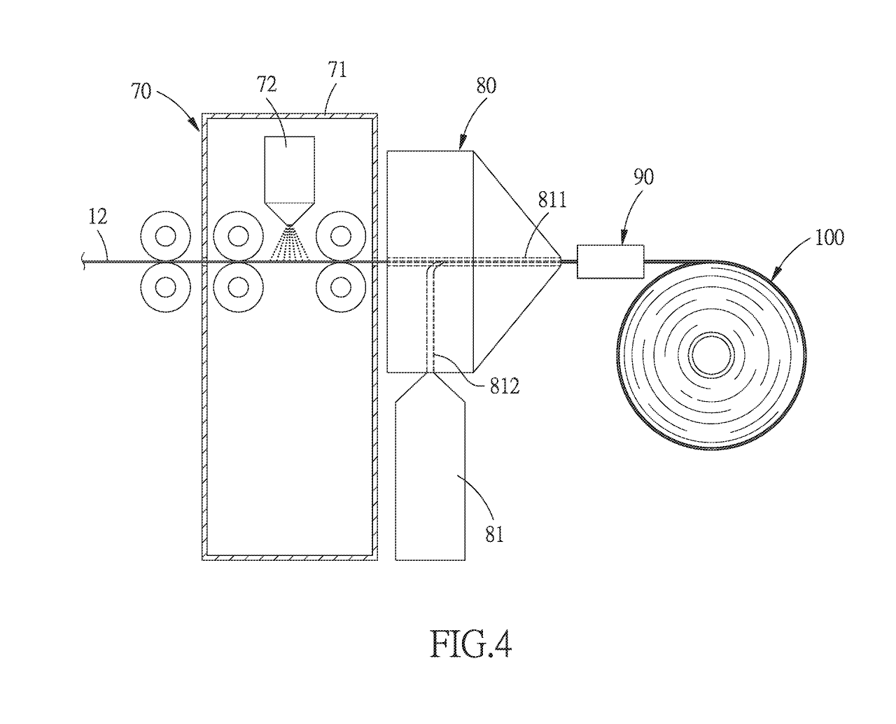

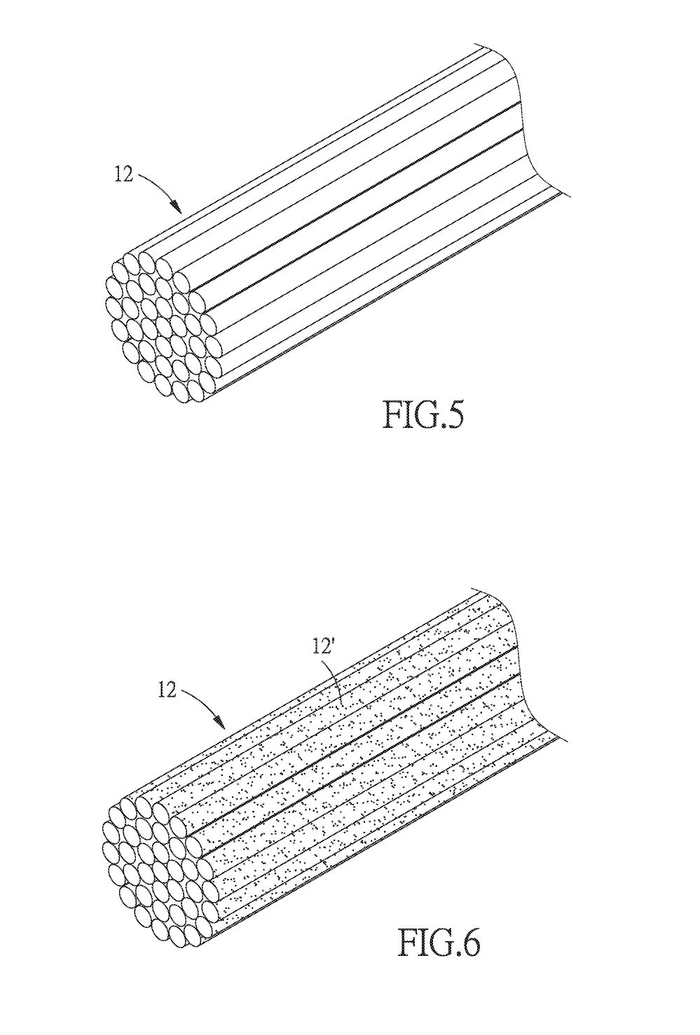

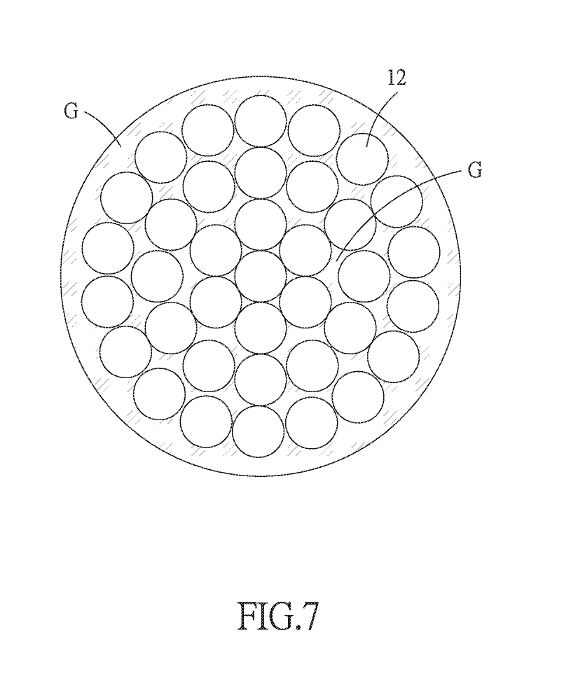

Referring to FIGS. 1-7, a carbon fiber bundle forming device in accordance with the present invention comprises: a feeding unit 10, a dehumidification unit 20, an induction heating unit 30, a first microwave heating unit 40, a second microwave heating unit 50, a laser unit 60, a roughening treatment unit 70, a resin forming unit 80, a semi-cure forming unit 90, and a rolling-up unit 100.

The feeding unit 10 includes a carbon-fiber-bundle-raw-material wheel 11 which provides at least one carbon fiber bundle 12.

The dehumidification unit 20 is connected to the feeding unit 10, and includes a dehumidification room 21. The at least one carbon fiber bundle 12 is fully dried after passing through the dehumidification room 21.

The induction heating unit 30 is connected to the dehumidification unit 20, and includes an induction heating room 31. The at least one carbon fiber bundle 12 is stabilized by being induction heated in the induction heating room 31 from room temperature to 500° C.

In this embodiment, the induction heating unit 30 further includes a preheating room 32. The induction heating room 31 includes a first induction heating area 311 and a second induction heating area 312. The preheating room 32 is connected to the dehumidification unit 20 and the first induction heating area 311, and has a temperature ranging from room temperature to 100° C. The first induction heating area 311 has a temperature ranging from 100° C. to 260° C., and the second induction heating area 312 has a temperature ranging from 260° C. to 500° C.

The first microwave heating unit 40 is connected to the induction heating unit 30, and includes a first microwave room 41. The at least one carbon fiber bundle 12 is carbonized by being microwave heated from 500° C. to 1000° C. in the first microwave room 41.

In this embodiment, the second induction heating area 312 is connected to the first induction heating area 311 and the first microwave heating unit 40.

The first microwave room 41 includes a first microwave area 411 and a second microwave area 412 connected to the first microwave area 411. The first microwave area 411 is connected to the second induction heating area 312 and has a temperature ranging from 500° C. to 850° C., and the second microwave area 412 has a temperature ranging from 850° C. to 1000° C.

The second microwave heating unit 50 is connected to the first microwave heating unit 40, and includes a second microwave room 51. The at least one carbon fiber bundle 12 is graphitized by being heated from 1000° C. to 1500° C. in the second microwave room 51.

In this embodiment, the second microwave area 412 is connected to the second microwave heating unit 50.

The laser unit 60 heats from 1500° C. to 3000° C., is connected to the second microwave heating unit 50, and includes a laser carbonization room 61. The at least one carbon fiber bundle 12 is heated by laser in the laser carbonization room 61 to graphitize an interior of the at least one carbon fiber bundle 12.

The roughening treatment unit 70 is connected to the laser unit 60 and includes a negative pressure room 71 which includes a roughening treatment member 72. The at least one carbon fiber bundle 12 is treated in the negative pressure room 71 by discharge gas continuously produced from the roughening treatment member 72, so as to produce a plurality of pits 12′ in the surface of the at least one carbon fiber bundle 12.

The resin forming unit 80 is connected to the roughening treatment unit 70, and includes an extrusion device 81. The extrusion device 81 includes: a conveying pipe 811 for conveying the at least one carbon fiber bundle 12, and an input pipe 812 for inputting a resin G into the conveying pipe 811 in a high pressure manner to enable the resin G to permeate into the interior of the at least one carbon fiber bundle 12 via the pits 12′.

The semi-cure forming unit 90 is connected to the resin forming unit 80 to receive the at least one carbon fiber bundle 12 from the extrusion device 81, and controls temperature and pressure to bring the at least one carbon fiber bundle 12 to a semi-cured state.

The rolling-up unit 100 is connected to the semi-cure forming unit 90 to roll up the at least one carbon fiber bundle 12.

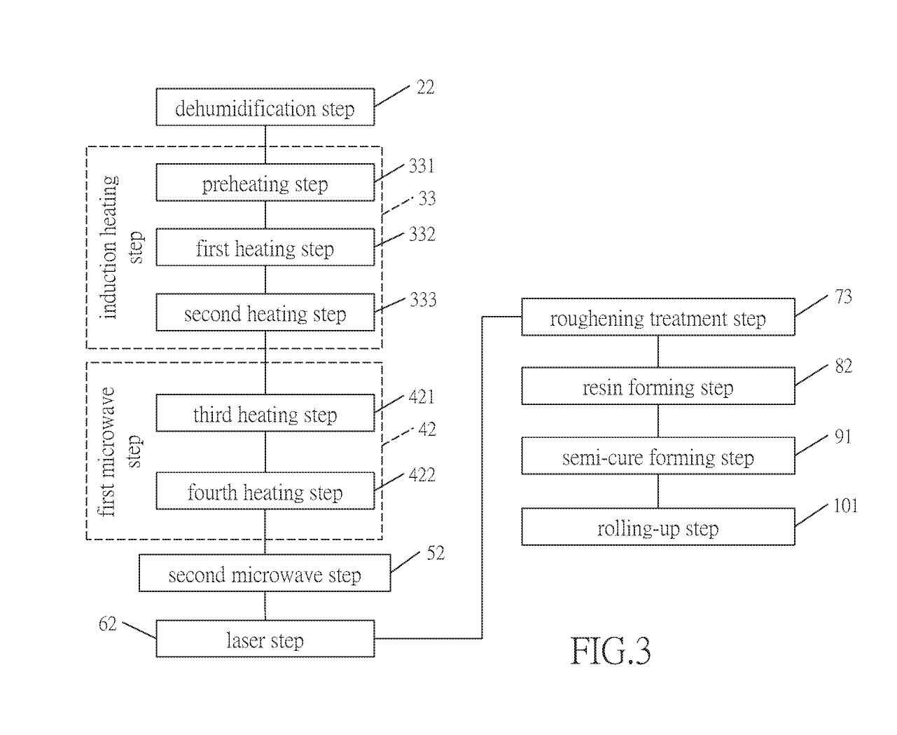

As shown in FIG. 3, the present invention further provides a carbon fiber bundle forming method, which comprises:

a dehumidification step 22 serves to dry at least one carbon fiber bundle 12;

an induction heating step 33 serves to stabilize the at least one carbon fiber bundle 12 by induction heating the at least one carbon fiber bundle 12 from room temperature to 500° C.;

In this embodiment, the induction heating step 33 sequentially includes: a preheating step 331, a first heating step 332 and a second heating step 333 which all heat objects with induction heating. The preheating step 331 is to heat the at least one carbon fiber bundle 12 from 0° C. to 100° C., the first heating step 332 heats the at least one carbon fiber bundle 12 from 100° C. to 260° C., and the second heating step 333 heats the at least one carbon fiber bundle 12 from 260° C. to 500° C.;

a first microwave step 42 serves to carbonize the at least one carbon fiber bundle 12 by microwave heating the at least one carbon fiber bundle 12 from 500° C. to 1000° C.;

in this embodiment, the first microwave step 42 includes a third heating step 421 and a fourth heating step 422 which all heat objects with microwave, the third heating step 421 serves to heat the at least one carbon fiber bundle 12 from 500° C. to 850° C., the fourth heating step 422 heats the at least one carbon fiber bundle 12 from 850° C. to 1000° C., and the at least one carbon fiber bundle 12 will be carbonized when heated from 500° C. to 1000° C.;

a second microwave step 52 graphitizes the at least one carbon fiber bundle 12 by microwave heating the at least one carbon fiber bundle 12 from 1000° C. to 1500° C.;

a laser step 62 serves to heat the at least one carbon fiber bundle 12 from 1500° C. to 3000° C. with laser illumination, so that graphitization takes place evenly inside the at least one carbon fiber bundle 12;

a roughening treatment step 73 serves to form a plurality of pits 12′ in an outer surface of the at least one carbon fiber bundle 12;

a resin forming step 82 serves to enable a resin G to be adhered to the outer surface of the at least one carbon fiber bundle 12 in a high pressure manner, and allows the resin G to permeate into an interior of the at least one carbon fiber bundle 12 via the pits 12′, so that the outer surface and the interior of the at least one carbon fiber bundle 12 is filled with the resin G; and

a semi-cure forming step 91 serves to bring the at least one carbon fiber bundle 12 into a semi-cured state by controlling environmental temperature and pressure of the at least one carbon fiber bundle 12.

Preferably, the present invention further includes a rolling-up step 101 serving to roll up the at least one carbon fiber bundle 12 which has been processed in the semi-cure forming step 91, and the at least one carbon fiber bundle 12 which has been rolled up can be used for subsequent processing.

The at least one carbon fiber bundle 12 can be evenly heated since it is heated with microwave in the first and second microwave steps 42, 52. Besides, the at least one carbon fiber bundle 12 is treated in the laser step 62, laser can reach into the interior of the at least one carbon fiber bundle 12, so that the interior of the at least one carbon fiber bundle 12 can be heated evenly, which allows the at least one carbon fiber bundle 12 to be carbonized evenly.

Furthermore, the first and second microwave steps 42, 52 only take about 30 minutes, therefore, the invention shortens the carbonization time of the at least one carbon fiber bundle 12 of the invention, as compared with the conventional induction heating method.

While we have shown and described various embodiments in accordance with the present invention, it is clear to those skilled in the art that further embodiments may be made without departing from the scope of the present invention.

What is claimed is:

1. A carbon fiber bundle forming device, comprising:
a feeding unit including a carbon-fiber-bundle-raw-material wheel to provide at least one carbon fiber bundle;
a dehumidification unit connected to the feeding unit, and including a dehumidification room, wherein the at least one carbon fiber bundle is dried after passing through the dehumidification room;
an induction heating unit connected to the dehumidification unit, and including an induction heating room, wherein the at least one carbon fiber bundle is stabilized by being induction heated in the induction heating room from room temperature to 500° C.;
a first microwave heating unit connected to the induction heating unit, and including a first microwave room, wherein the at least one carbon fiber bundle is carbonized by being microwave heated from 500° C. to 1000° C. in the first microwave room;
a second microwave heating unit connected to the first microwave heating unit, and including a second microwave room, wherein the at least one carbon fiber bundle is graphitized by being heated from 1000° C. to 1500° C. in the second microwave room;
a laser unit heating temperature from 1500° C. to 3000° C., being connected to the second microwave heating unit, and including a laser carbonization room, wherein the at least one carbon fiber bundle is heated by laser in the laser carbonization room to graphitize an interior of the at least one carbon fiber bundle;
a roughening treatment unit connected to the laser unit and including a negative pressure room with a roughening treatment member, wherein the at least one carbon fiber bundle is treated in the negative pressure room by a discharge gas continuously produced from the roughening treatment member, so as to produce a plurality of pits in an outer surface of the at least one carbon fiber bundle;
a resin forming unit connected to the roughening treatment unit, and including an extrusion device, wherein the extrusion device includes: a conveying pipe for conveying the at least one carbon fiber bundle, and an input pipe for inputting a resin into the conveying pipe in a high pressure manner to enable the resin to permeate into the interior of the at least one carbon fiber bundle via the pits;
a semi-cure forming unit connected to the resin forming unit to receive the at least one carbon fiber bundle extruded from the extrusion device, wherein the semi-cure forming unit controls temperature and pressure to bring the at least one carbon fiber bundle to a semi-cured state; and
a rolling-up unit connected to the semi-cure forming unit to roll up the at least one carbon fiber bundle.

2. The carbon fiber bundle forming device as claimed in claim 1 further comprising a preheating room which includes a first induction heating area and a second induction heating area, the preheating room is connected to the dehumidification unit and the first induction heating area, and has a temperature ranging from room temperature to 100° C., the first induction heating area has a temperature ranging from 100° C. to 260° C., and the second induction heating area is connected to the first induction heating area and the first microwave heating unit, and has a temperature ranging from 260° C. to 500° C.

3. The carbon fiber bundle forming device as claimed in claim 1, wherein the first microwave room includes a first microwave area and a second microwave area connected to the first microwave area, the first microwave area is connected to the second induction heating area and has a temperature ranging from 500° C. to 850° C., and the second microwave area is connected to the second microwave heating unit and has a temperature ranging from 850° C. to 1000° C.

4. A carbon fiber bundle forming method, comprising:
a dehumidification step serving to dry at least one carbon fiber bundle;
an induction heating step serving to stabilize the at least one carbon fiber bundle by induction heating the at least one carbon fiber bundle from a room temperature to 500° C.;
a first microwave step serving to carbonize the at least one carbon fiber bundle by microwave heating the at least one carbon fiber bundle from 500° C. to 1000° C.;
a second microwave step serving to graphitize the at least one carbon fiber bundle by microwave heating the at least one carbon fiber bundle from 1000° C. to 1500° C.;
a laser step serving to heat the at least one carbon fiber bundle from 1500° C. to 3000° C. with laser illumination, so that graphitization takes place inside the at least one carbon fiber bundle;
a roughening treatment step serving to form a plurality of pits in an outer surface of the at least one carbon fiber bundle;
a resin forming step enabling a resin to be adhered to the outer surface of the at least one carbon fiber bundle in a high pressure manner, and allowing the resin to permeate into an interior of the at least one carbon fiber bundle via the pits, so that the outer surface and the interior of the at least one carbon fiber bundle is filled with the resin; and
a semi-cure forming step serving to bring the at least one carbon fiber bundle into a semi-cured state by controlling environmental temperature and pressure of the at least one carbon fiber bundle.

5. The carbon fiber bundle forming method as claimed in claim 4, wherein the induction heating step sequentially includes: a preheating step, a first heating step and a second heating step which heat objects with induction heating, the preheating step serves to heat the at least one carbon fiber bundle from 0° C. to 100° C., the first heating step heats the at least one carbon fiber bundle from 100° C. to 260° C., and the second heating step heats the at least one carbon fiber bundle from 260° C. to 500° C.

6. The carbon fiber bundle forming method as claimed in claim 4, wherein the first microwave step includes a third heating step and a fourth heating step which heat objects with microwave, the third heating step serves to heat the at least one carbon fiber bundle from 500° C. to 850° C., the fourth heating step heats the at least one carbon fiber bundle from 850° C. to 1000° C., and the at least one carbon fiber bundle will be carbonized when heated from 500° C. to 1000° C.

7. The carbon fiber bundle forming method as claimed in claim 4 further comprising a rolling-up step serving to roll up the at least one carbon fiber bundle which has been processed in the semi-cure forming step, and the at least one carbon fiber bundle which has been rolled up is be used for subsequent processing.
